(19) United States
(12) Patent Application Publication
(10) Pub. No.: US 2014/0279328 A1
(43) Pub. Date: Sep. 18, 2014

(54) METHOD AND SYSTEM AUTOMATES A COMPREHENSIVE, ON-GOING SURVEY OF FORWARD-LOOKING FINANCIAL ESTIMATES ENTERING PROJECTED FINANCIAL STATEMENTS AND VALUATION CALCULATIONS

(71) Applicants: Laxmisekar Pendem, Chantilly, VA (US); William A Ryan, Jr., Baltimore, MD (US)

(72) Inventors: Laxmisekar Pendem, Chantilly, VA (US); William A Ryan, Jr., Baltimore, MD (US)

(21) Appl. No.: 14/035,235

(22) Filed: Sep. 24, 2013

Related U.S. Application Data
(60) Provisional application No. 61/802,873, filed on Mar. 18, 2013.

(51) Int. Cl. G06Q 40/00

(52) U.S. Cl. CPC G06Q 40/00
USPC 705/35

(57) ABSTRACT

The invention embodies a method, and computer software, that automates comprehensive surveys of forward-looking numeric estimates, in financial valuation models, of companies that report period financial results to the United States Securities and Exchange Commission (US SEC). The method provides an immediate, in-kind exchange of financial information, so that a participant may compare his or her individual estimates, to an aggregation of peer estimates, in the same categories. The method specifies survey categories as: (i) the exact accounting categories used by the company in its period financial reports to the US SEC, or, (ii) the exact adjustments used to convert “accrual accounting” values to the “cash accounting” values used in the valuation method of “discounting free cash flows to the firm”. The claim specifies test criteria for: fidelity to the accounting categories of the reporting company; comprehensiveness of the survey; and, an immediate feed-back of in-kind information to participants.

### CROSS-REFERENCE TO RELATED APPLICATION(S)

The present application is related to U.S. Provisional Patent Application 61/802,873 filed Mar. 18, 2013.

### BACKGROUND OF THE INVENTION

1. Field of the Invention

The invention relates to the process by which financial analysts estimate the present value of securities issued by a company or municipality (entity). This valuation process includes creation of a projected financial model of the entity, and, calculation of the present value of its future cash profits. Each component, of projected (“forward-looking”) financial income statements, balance sheets, and valuation calculations, is uncertain. Because of this uncertainty, analysts often seek to compare the line-item values, in their own projection models, to those of their peers. However, no formal process exists to help independent analysts compare their projections. A current informal comparison process, by which “buy-side” (mutual fund, pension fund, or foundation) financial analysts compare their own estimates to the financial models of a small group of “sell-side” (investment bank) financial analysts, has been criticized as narrow and biased. This invention introduces a practical, comprehensive facility that automates continuous, detailed comparison of every specific forward-looking estimate, in the financial models and valuation calculations, of a broad sample of independent financial analysts.

2. Description of the Background

Every working day, investors execute billions of transactions to buy and sell equity and debt securities. In each transaction the buyer expects the value of the security to rise from its current market price and the seller expects it to fall. Securities markets are a social mechanism for airing differing views on the present value of the future economic activities of companies and municipalities. A prudent investor enters a securities market transaction only after completing an independent, thorough estimation of the expected “intrinsic” value of a specific security. When the investor's estimate of the intrinsic value (or “target price”) of the security differs from the current market price, he or she makes an investment. The investor takes a “long” position if the market price is now below his (her) target price, or, the investor takes a “short” position if the market price is now above his (her) target price. The investor profits if the actual market price converges to his (her) target price. Every rational investment action occurs in the context of laying a bet contrary to a general expectation in the market. Only an investor, who understands both the context of current market-consensus prices and the sources of his (her) disagreement with the consensus, can be said to make a rational investment action.

Financial analysts and investors use two general methods to estimate values for securities: “relative” valuation methods and “absolute” valuation methods.

Relative valuation methods provide quick approximations of value for securities, but, because they depend on pricing of other securities, they suffer from logical circularity and can accentuate instability in markets. In the simplest form of the relative valuation method, the analyst compiles a list of companies in the same industry and in the same general stage of maturity as the subject company. These are the “comparables” to the subject company. The analyst then lists: (1) the most recent reported (historical) revenues and earnings of each of the comparable companies, (2) estimates of next-period revenues and earnings of each comparable company, and then, (3) identifies the current market prices for the common-stock of each of the comparable companies. Next, the analyst calculates ratios of: (a) current-price divided by next-period-revenue (the “price to revenue ratio” or “P/R” ratio), and, (b) current-price divided by next-period-earnings (the “price to earnings ratio” or “PIE” ratio). The arithmetic average of the P/R ratios of the comparables, and the arithmetic average of the P/E ratios of the comparables, can each be used to estimate an approximate value for the subject company. The analyst simply multiplies the average comparables P/R times his (her) projection for the next-period revenues of the subject company, to estimate a reasonable target price. Likewise, the average comparables P/E ratio can be multiplied by the analyst's projection for next-period subject company earnings, to estimate the target price.

Relative valuation methods are useful for quick approximation of the present value of a company, but should not be trusted for use in a final investment decision. Relative valuation methods rely on only two measured parameters, company revenue and earnings, to express the effect of numerous, economic, and accounting influences on company business. Relative valuation also relies on the pricing of peer companies. Errors in pricing of peers can be carried into the analysis of the subject company, and, when accumulated across numerous company valuations, can magnify “booms” or “busts” in securities markets.

Absolute valuation methods (also called “intrinsic value” or “fundamental analysis” methods) view the present value of an entity as the sum of all its future cash profits, discounted to present-time dollars, over an indefinite operating life. Intrinsic valuation has the advantage of considering each entity as a stand-alone business and so avoids the potential for the circular-reference effect of relative valuation. Intrinsic valuation methods also explicitly examine dozens of line-item components in projected income statements and projected balance sheets of the subject entity. This helps the analyst to track more of the independent factors that determine the total revenues and earnings the entity may generate in each future year. Careful consideration of factors affecting each separate line-item decreases the chance that an important economic or accounting influence might be overlooked.

The first step in the absolute valuation process is to create a financial projection model of the subject entity. Financial projections are simply descriptions of possible future income statements and balance sheets of the subject, sketched four or five years into the future. Usually, the model is structured so that the projected income statements and balance sheets use exactly the same accounting line-item category names (such as “Revenues”, “Cost of goods”, etc., in the Income Statement, and “Cash and cash equivalents”, “Marketable securities”, etc., in the Balance Sheet) as used by the subject company in its period financial reports to the United States Securities and Exchange Commission, in forms 10-Q and 10-K. The analyst must create estimates for approximately 150 to 300 financial line-item values, in a matrix specified by the accounting line-item categories of the entity's Income Statements and Balance Sheets, projected forward for five years. The complexity of financial models varies by industry. The income statements and balance sheets of some utilities or banking companies can hold twice the number of accounting line-items as those of service companies or manufacturing companies.

Subsequent steps in the absolute valuation process involve converting values of accrual-accounting line-items to values appropriate to cash-accounting, then converting future year values to values compatible for summation with current-year dollars. Absolute valuation models also include an estimate of entity value beyond the initial five years of the model. The details of these calculations are not important to understanding this invention. A concise description of the steps to calculate absolute valuation by discounting free cash flows to a firm appears in Arzac, E. R.; Valuation for Mergers, Buyouts and Restructuring, John Wiley & Sons, Inc. (2005). The important things to understand are: (i) the absolute valuation process requires multiple distinct numeric inputs, (ii) the future value of each input is uncertain, (iii) analysts think carefully about their choice of each input, and, (iv) analysts want to compare their choices of each input to those made by peers.

While the complexity of financial modeling and absolute valuation can be off-putting to impatient asset traders, professional financial analysts relish the detail. A detailed disclosure of specific product revenues, specific expenses, and of specific assets and liabilities, all provide conceptual “entry points” for diligent investigation, unique discoveries, and distinct investment conclusions. Each accounting line-item in the income statement and balance sheet of an entity is driven by several economic and accounting factors. Taken one at a time, the analysis of each factor is manageable and can produce defensible conclusions. If a portfolio manager asks an analyst why the stock of a subject company is under- or over-priced, the results of a detailed line-by-line analysis can provide persuasive arguments to support an investment hypothesis. A substantial difference between an estimated value in an individual analyst's projection model of a specific company, and the same line-item value in a market-consensus projection model of that company, may highlight a rational opportunity to profit.

An important question is: how does an independent financial analyst acquire an accurate, comprehensive representation of the “market-consensus” financial projection model of a subject company? The short answer is: no comprehensive representations of market-consensus projection models now exist. Currently, “buy-side” financial analysts have access to a small-sample of financial projection models, published by “sell-side” financial analysts. Sell-side analysts provide “free” copies of their projection models to buy-side investors, in a tacit agreement that the buy-side analyst will place subsequent (commission-paying) trading orders through the sell-side firm. Some buy-side investors aggregate the models of three or four sell-side analysts, to create a small-sample approximation of the market consensus financial projection model for a subject company. Most buy-side investors do not labor to calculate such a line-by-line aggregate consensus model. One impediment is that sell-side reports often use slightly different accounting line-item categories, so the reports cannot be aggregated, directly. Most buy-side asset managers rely on two comparisons: (a) a simple inspection of a few favorite-source sell-side models, and, (b) a glance at the Thompson-Reuters quarterly survey of sell-side opinions on just “Revenue” and “Earnings” accounting line-items for the up-coming quarter.

The investment community is aware that the practice of relying on the estimates of a few sell-side financial analysts, as a proxy for the market consensus financial model of a subject company, may be subject to persistent biases. First, many buy-side investors worry that the typical sample size, of between five and fifteen sell-side analysts “covering” a given company, is too small to accurately represent the true central tendency of opinions of the larger investment community. Excessive enthusiasm or pessimism, of any single sell-side analyst, can skew this small-sample representation of the “market view”. Second, many investors worry about the link between sell-side analysts and their sell-side firm's investment banking business. Third, many investors worry about the need for sell-side analysts to maintain a friendly personal relationship with the managers of a subject company. If a sell-side analyst publishes a negative opinion about a subject company, often, subject-company managers retaliate by failing to return phone calls to the offending sell-side analyst, and, by failing to contact the offending firm's investment bankers when preparing its next stock or debt offering. Sell-side firms put quiet pressure on their (sell-side) analysts to publish only positive reports about any subject company.

The present invention creates a statistically accurate and comprehensive representation of the investment community consensus financial projection model and valuation calculations, for any subject-company or municipality that reports period financial results to the United States Securities and Exchange Commission (“US-SEC”). The invention's statistical accuracy is accomplished by seeking a large-sample aggregate of every line-item component, for inclusion in its “Wiki Financial Analyst” (“Wiki-FA”) database. Each accounting line-item category, in the Wiki-FA database, uses precisely the same nomenclature as that used by the subject-company in its period financial reports to the US-SEC. This accounting format is expected by buy-side analysts and allows direct aggregation of opinions from multiple contributors. The Wiki-FA database collects one opinion, for each line-item category, from each contributor.

A patent provided to the Wiki Financial Analyst will serve the interests of accuracy and stability in securities markets. Creating a single, central database will help develop a large sample size, and an accurate representation of the central tendency of community opinion on the line-item values in the consensus financial projection models and consensus valuation calculations, for all subject entities. Patented exclusivity will not affect prices to contributors, as the Wiki-FA service is free to any user who registers and contributes numerical opinions to the Wiki-FA database. Wide adoption of the Wiki-FA service may increase the use of fundamental valuation techniques and so improve the stability of asset markets. Use of the Wiki-FA service may decrease the contribution of biased sell-side analysis, and, may decrease the contribution of circular-reference relative-valuation methods, to market pricing instability.

### SUMMARY OF THE INVENTION

For the convenience of the reviewer, the following summary outlines the material components, dynamic functions, and the conceptual intent of the invention. This summary does not attempt to specify elements that could determine the priority or novelty of the invention.

This invention consists of software operating on a digital server, and software accessible to users accessing an internet website, that combine to organize the function of a database. This database accepts, stores, and displays aggregated numerical values of financial estimates, for the several hundred time-specified, accounting line-item categories in the projected income statements, balance sheets and discounted cash flows calculations that underlie the value of each, of approximately ten thousand, companies that report period financial results to the United States Securities and Exchange Commission. The system accepts numerical value estimates, from an unlimited number of contributors, through data-entry dialog boxes on the internet website. The system displays statistical descriptions of the aggregated values in each time-specified, accounting line-item category.

Broadly conceived, this invention creates a comprehensive communication facility for exchange of detailed, quantitative, financial-modeling and securities-value hypotheses between independent investment thinkers. Specifically, the invention operates as a continually-updating survey of investor opinion, focused on the numeric values of components of financial projection models, and, the numeric values of components used in calculating the absolute value of a subject company or municipality (by the method of discounting free cash flows to the firm). We call this opinion survey system the “Wiki Financial Analyst”. The Wiki Financial Analyst database uses exactly the same, specific, accounting line-item categories, as those used by each company reporting its period financial results to the United States Securities and Exchange Commission. For each line-item category in our database, our system calculates statistical parameters that describe the shape, central tendency and dispersion of each aggregate. The invention provides a detailed and comprehensive context by which an independent financial analyst may compare his (her) own research findings to those of his (her) peers. Such a comparison may prompt the analyst to reconsider the assumptions and evidence underlying his (her) financial projections and securities value calculations, or, highlight a rational basis for potential investment action.

The aggregated research opinions of a large number of independent, buy-side financial analysts may prove more predictive of actual events than those of a small number of exceptionally-intelligent, sell-side financial analysts. Recent economic research indicates that the central tendencies of opinion-aggregates (in prediction markets) can be more accurate predictors, of actual events, than the forecasts of individual experts (see The Wisdom of Crowds, by James Surowiecki, and, The Difference, by Scott E. Page). This effect is likely generated by the comparative thoroughness of the research of one exceptionally intelligent analyst, such as a “star” analyst working at a sell-side financial firm, and the thoroughness that can be generated by aggregating the opinions of a hundred independent-thinking, well-educated buy-side analysts. It comes down to who misses less information. In a one-on-one competition, one exceptionally-intelligent person will generally capture and consider more information than one normally-intelligent person. This advantage disappears when a hundred normally-intelligent, well-educated people are sent to gather information. If the normal people fail to aggregate their findings, the “star” still wins. If the normal people aggregate their findings, they will often out-perform even the smartest single person. We hypothesize that, for any given subject company, aggregation of the research of hundreds of buy-side analysts will be more predictive of actual events than the expert opinions of “star” sell-side analysts covering that same company.

This invention may improve the accuracy and stability of prices in securities markets. Wide adoption of our service may increase the use of rational, “fundamental” valuation techniques, may decrease the use of circular-reference “relative” valuation methods, and may decrease the influence of possibly biased sell-side analysis.

This invention serves the interest of professional financial analysts, who investigate factors that create economic value. Businesses and governments engage in numerous complex activities and are subject to influence by numerous economic forces. A sudden change in any one (or more) economic factor(s) can create sudden changes in the value of the securities of the company or municipality. Financial analysts must track all these factors. Analysts cope with this potentially overwhelming task, by conceptually “breaking-apart” the economic activity of the subject and examining the components separately. The profession has developed a practice of organizing these economic components by accounting representations in income statements, balance sheets, and statements of cash flows. Each financial statement line-item represents a manageable number of underlying economic processes. Creating a financial projection model of a subject company, describing all components entering its future cash profits, and then discounting all these future profits to a single cumulative present value, allows the analyst to “unpack” and examine all of the economic components of the company or government and then re-assemble them to price its securities.

The social utility of this invention would be optimized by patent protection. The exclusivity provided by a patent would help concentrate contributions of financial estimates to a single database, thereby increasing the sample size and rendering a more statistically accurate representation of investment community opinions. Exclusivity would not burden our contributors financially, as our service is free to any user who registers and contributes numerical estimates to our database. Indirect competitors are well-established. Several investment banking firms issue financial research reports, delineating the financial projection model and valuation calculations of individual analysts, expert on the subject-company. These “sell-side” financial research reports are free to buy-side analysts whose firm places trading orders with the sell-side firm.

### BRIEF DESCRIPTION OF THE DRAWINGS

FIG. 1 depicts a “Home” page of the www.wikifinancialanalyst.com website. This “Home” page provides an initial orientation to visitors. The banner indicates the “Wiki Financial Analyst” name (“WFA”), and, the underlying legal disclaimer specifies some of the limits that the prospective user should respect. The four Tabs (“Home”, “About”, “Experts”, and “Contact”) indicate website information which is available to any visitor who opens the website. Each these initial Tabs provide its own specific explanations and instructions. The Registration process requires that the User have attained professional expertise in constructing financial projection/valuation models, and, that the User agrees to professional standards of conduct. Additional Tabs become available when the visitor registers as a Member of the Wiki Financial Analyst Information Network.

FIG. 2 summarizes the process by which a Registered Member may deposit his or her forward-looking financial estimates into the Wiki Financial Analyst database. The Member must have created an integrated income statement/balance sheet projection model of the subject-company, and, must have prepared calculations of subject-company value by the method of discounting free cash flows to the firm. The Member then saves a working “Donor” copy of his or her model. This working copy must be modified to a standard format (Microsoft Excel's “Number” format) so that all values copied from the “Donor” worksheet will be in a form acceptable to the Wiki Financial Analyst database. The User then employs the Excel “Copy-Paste” functions to transfer each projected numerical value, from each specific “Donor” accounting line-item and forward-period (in his/her “donor” worksheet), to a specific “Recipient” dialog box, for the same accounting line-item and forward-period in the Wiki Financial Analyst web-page. Such copy-paste actions ensure that data transfers are wholly voluntary. When the user has completed all desired data transfers, he or she clicks the “Submit” button, to deposit all estimates, from the WFA web-page, into the WFA database, and, to activate displays of his/her data in the context of statistical distributions of estimates.

FIG. 3 depicts the first display seen by the user, after submitting his/her estimates to the Wiki Financial Analyst database. This first display is a time series of the arithmetic mean values of the Wiki Financial Analyst aggregated estimates, in each accounting line-item and forward-period. We call this a “Comprehensive View” because it displays a complete projection model of the specific financial statement. Each subject-company is represented, in the Wiki Financial Analyst database, by five financial statements: an annual income statement (K-IS), an annual balance sheet (K-BS), an annual discounted free cash flows to the firm calculation (DFCFF), a quarterly income statement (Q-IS), and, a quarterly balance sheet (Q-BS). (Annual and quarterly statements are collected separately because companies sometimes alter the meaning of accounting categories in unaudited quarterlies versus audited annuals.) To view the position of his/her estimates, in the context of the aggregated estimates of all other users, for the same accounting line-items and forward periods, the user clicks the “Expand” button. This opens a “Selective View” of the User's estimates, for a single forward period, and statistical descriptors of each data aggregate.

FIG. 4 displays the user's estimate (“U”), in the context of other estimates deposited by all other users, in the same accounting-time categories. The reliability of the statistical calculations is indicated by the sample size (N) (samples of more than 30 independent estimates are considered reliable representations of the shape and scope of the population). Our software calculates statistical parameters that describe: the central tendency of the aggregated data (the mean); the spread of the data from the center (the standard deviation); the symmetry of the data about that mean (the skew); and, the “peaky-ness” or “flatness” of the distribution (the excess kurtosis). To measure how far the User's estimate is positioned from the central tendency, our software calculates of [(U−X)/(Std.Dev)]. Professional financial analysts are well-acquainted with the idea that an estimate, lying within two standard deviations of the mean, has a 95% probability of being a “member” of the process that produced the “main body” of the distribution. If his or her estimate lies outside +/− two standard deviations from the center, that estimate is likely “outside of the distribution” (an “extremist view”). The analyst may wish to reconsider any “extremist” estimate. If, on careful review, the analyst still prefers the “extreme” view, he/she may have located a true disagreement with the consensus. This may be a basis for a rational “active investment”.

### DETAILED DESCRIPTION OF THE PREFERRED EMBODIMENTS

The invention consists of software, operating on a digital computer server, that manages a central database, and, that communicates with human-users via an internet website. The database collects and organizes information in specific survey categories related to: (1) confidential human-user identifying-information; (2) identifying-information for each subject-company (or municipality) that reports period financial information to the United States Securities and Exchange Commission (US SEC) or other monitor of business accountability; (3) the specific financial statements that structure database-representation of each subject-company (or municipality); and (4) the actual numeric values, for future time-specified, accounting line-item estimates, deposited into our database by the human-users. Confidential user-identifying information is retrievable only by the same user and by our administrators. Our database is readily scalable to accommodate 500,000 independent users; 500 time-specific, projected accounting line-item categories per subject-company; and 50,000 companies or municipalities reporting to the US SEC. This creates a potential matrix of approximately 25 million separate survey categories, into which users may load ten trillion separate projected numeric estimates.

Financial analysts examine period financial reports to conduct one of two general types of analysis: a comparison of several companies at a single point in time (a cross-sectional analysis) or a comparison of one company over several time-periods (a time-series analysis). The categories to be used in the survey are determined by the purpose of the survey. In a cross-sectional survey, accounting line-item categories are selected to maximize the comparability between several companies. For cross-sectional analysis, researchers often merge two or more accounting categories, from one company, to make them more compatible. In a time-series survey, each company is studied independently of others and the survey categories are highly specific to the single subject company. For a time-series study, modifying accounting line-item categories tends to confuse interpretation.

Theoretically, both cross-sectional and time-series analyses can be constructed to examine either historical relationships or projected future relationships among data. Dozens of financial information providers organize databases of historical financial data, slightly modified by accounting category, to enable cross-sectional analysis. Other financial information providers maintain databases of the exact historical period reports made by companies and municipalities to the US SEC, as submitted on Forms 10-K (annual) and Forms 10-Q (quarterly). These are suitable for historical time-series analysis. We are unaware of any provider that organizes a comprehensive survey of forward-looking estimates, either by modified categories, suitable for cross-sectional analysis, or, by the exact accounting categories of the reporting entity, suitable for time-series analysis.

This invention surveys estimates that are employed in the “fundamental valuation” method of determining the present value of the cash-accounting profits of each subject-company (or municipality). This valuation method is a form of time-series analysis and so requires strict adherence to the accounting categories used by the entity when it makes its period financial reports to the US SEC. This method also requires forward-looking data, rather than historical data. Past economic activity is useful only so much as it may indicate the trajectory of future economic activity. The actual present value of the securities of a company or municipality is calculated by estimating all future cash profits and discounting each future year's dollars to present-year dollars. The sum of all these discounted cash profits is considered the total present value of the entity. Any survey gathering data to create a community-consensus valuation model for a given subject must: (1) employ survey categories that are highly specific to each subject-company; (2) collect forward-looking numerical estimates for each category; and (3) do both (1) and (2) in a cost-effective manner.

A difficulty arises from the variability of the form of financial statements. The specific accounting line-items of the income statement or balance sheet of a banking company or utility can be very different than those used by an industrial manufacturer or service provider. Even for the same company, the accounting line-items for a quarterly statement may be slightly different from those used in an annual report. If the survey focuses on one or two companies, database categories can be hand-crafted to reflect the exact accounting categories of the financial statements of the subject. For a survey covering hundreds or thousands of entities, hand-crafting the data-input and data-display categories is not feasible. At least some automation is required to create comprehensive coverage.

The invention operates a novel method to create the database categories that represent each subject-company in our database. These are the categories that will accept user estimates for each time-specific, accounting line-item, in the projected annual and quarterly income statements, annual and quarterly balance sheets, and calculations of discounted future cash profits for each subject-company or subject-municipality. This novel category-creation method requires human action to: (1) select a specific historical financial statement from the “EDGAR” website operated by the US SEC, (2) capture the statement as an Excel worksheet, (3) edit the worksheet to remove unwanted information, and then, (4) uses a “Browse” dialog box to identify the Excel worksheet file and trigger an automatic up-load of the form and content of the worksheet, to create the database categories and to specify the form of the web-pages that accept and display user estimates for the subject-company. The software automatically converts the two-dimensional matrix of worksheet cells into: (A) survey categories for the database, (B) website pages for accepting forward-looking estimates from users, and, (C) website pages displaying aggregated data statistics. The database categories are defined by the exact accounting names for line-items in the SEC EDGAR worksheet (worksheet row headers) and by the exact expected future dates of upcoming period financial reports (worksheet column headers). For the data-accepting web-pages, the software creates dialog boxes, positioned on the web-page in a two-dimensional matrix defined by these row and column headings. These dialog boxes both identify the survey categories and provide a place for the user to enter his or her estimates, for each accounting line-item in each specific future period. Display pages, showing statistical descriptions of the aggregates in each database category, are also defined by these same accounting line-item names and expected future report schedule. Operation of this semi-automated category-creation method, for one subject-company, requires less than five minutes. Hand-crafting individual web-pages using standard web-page creation software could consume hours.

Potential users make initial contact with the invention by linking to an internet website through www.wikifinancialanalyst.com. (Please refer to FIG. 1.) The initial “Home” page briefly explains the mutual benefits of participating in the comprehensive survey of forward-looking financial projections, and, instructs the user how to begin using the services. The user is encouraged to open the “About” tab, which provides a comprehensive explanation of services and discloses the statistical methods and accounting rules used to operate the survey. The “Home” and “About” tabs are accessible to any person who activates the link to the website. Other tabs (and their functions) are activated only after the user completes a Registration Agreement. No fee is charged for registration, but, by submitting the completed registration form, the user agrees to abide by specific rules governing the quality of estimates to be deposited into the Wiki-FA database, and, rules governing the personal conduct required to preserve the integrity of the survey. The integrity of the survey requires “reasonable-basis, good-faith estimates”. Among professional financial analysts, the term “reasonable-basis, good-faith estimates” indicates that the financial projections are the result of a substantial investigation of future economic activities of the subject and that the report of the projections intends no deceit. Registrants also agree to refrain from contributing any portion of a copyrighted or trade-secret research report, as well as, to refrain from disclosing material insider information of their firm.

The “Companies” Tab mediates the user's initial encounter with a Wiki-FA survey. (Please refer to FIGS. 2, 3, and 4.) The web-pages opened by this Tab assist the user in choosing a subject-company and in choosing the type of financial statement. An initial selection page lists all companies for which the Administrator has created database categories, and, provides a choice from among five types of accounting statements (annual and quarterly Income Statements, annual and quarterly Balance Sheets, and DFCFF calculations). The user also chooses whether to participate by free “Deposit-for-View” service, or, to participate by “Pay-for-View”. Deposit-for-View is our basic, free, in-kind exchange of numeric opinions. Pay-for-View is available to accommodate the interest of portfolio managers and asset traders who do not make detailed projection models in their work process, or, to accommodate financial analysts whose employer prohibits sharing of financial research outside the firm. The price for a Pay-for-View subscription, for one subject-company, is set to approximately equal to the dollar-time cost (of approximately 20 to 30 minutes, at an analyst's base pay rate) expended by a Deposit-for-View analyst contributing a full five-statement set of estimates for one subject-company.

To activate Deposit-for-View service, the user selects a “Deposit-for-View” tab. This activates the link to the Deposit web-page for the desired company and future accounting statement. This web-page contains the matrix of dialog boxes that provide space for the user to deposit forward-looking estimates for each accounting line-item, in each specified future period financial report. After copying estimates, from his or her projection model, to our dialog boxes, the user activates a “submit” function and the data is transferred and aggregated into each appropriate database category. The Wiki-FA database calculates statistical descriptors of the aggregated values in each category (e.g.: mean, median, standard deviation, skew and kurtosis) and displays the statistical mean value of each category, in a one-period format. The accounting line-item names comprise the first column. The statistical descriptors (mean, median, etc.) are displayed in subsequent columns. A pair of “Forward-Back” buttons allows the user to toggle from one projected period to the next. In Deposit-for-View, the database reveals statistical descriptions only for categories to which the user made a contribution. We call this “Selective Display”.

If an analysts wishes to view a complete matrix of aggregate mean values, in the standard multiple-projection-period format for financial projection models, he or she may either: (a) contribute a complete set of forward-looking estimates in all five financial statement types, or, (b) purchase a Pay-for-View subscription. Both provide a “Comprehensive Display” of all projected time periods (three quarters or five annuals) for all the accounting line-item categories for that subject-company. All statistical descriptors can be viewed by clicking an “expand” button at the head of each column (single projected time-period). This converts the “Comprehensive Display” of the mean values of every aggregate, to the “Selective Display” for the selected future report-period, showing the mean, median, standard deviation, skew, and kurtosis, for each line item in the single chosen future financial report-period.

The “Account” Tab allows the user to re-visit and revise any estimates he or she previously deposited into the Wiki-FA database. It provides the pathway to correct errors and/or alter estimates as events change. As with the “Companies” Tab, the initial web-page assists the user in selecting a company, type of financial statement, and future reporting period, for reviewing. After the company and type of statement have been selected, the next web-page displays the current user-estimate and the current mean-database-estimate, for each selected accounting line-item, and provides a dialog box into which the user may enter a replacement value. If the dialog box is left blank, the existing user-estimate is retained. If a replacement value is entered, it displaces the prior deposit. Our database maintains a “date tracker” that date-stamps each accepted entry, to determine the beginning of the Deposit-for-View period. Deposit-for-View provides the same full-year viewing privilege as Pay-for-View, but is restricted to showing only those categories into which the user deposited an estimate. For every category, an analyst may extend viewing privileges indefinitely, by repeatedly replacing old estimates with refreshed estimates.

The “Admin” Tab may be activated only by Administrators of the Wiki Financial Analyst, to: (a) create representation categories for new companies to the Wiki-FA database, (b) monitor the quality of estimates deposited into the database, (c) communicate with registered members (by e-mail), and (d) to resolve operational problems. The semi-automated method for structuring survey categories, for companies new to our database, has been described in the section labeled “Semi-Automated Structuring of Database Categories” under the “Description of Database Dimensions and Functions” header, above. The Administrator may activate the displays from the “Account” Tab for any Registered User, solely for the purpose of determining if estimates appear in the form of reasonable-basis, good-faith financial research. Estimates which are within one or two standard deviations of the median aggregate estimate, and, which follow approximate-expected proportion to key values (such as “Revenues” and “Total Assets”), are likely to be the result of reasonable-basis financial research. Latitude is provided for a wide range of estimates. Certain other sets of estimates are clearly identifiable as bad-faith. For example, a set of estimates which all take the value of “1” are not expected in an Income Statement or Balance Sheet and may represent a fraudulent attempt to obtain viewing privileges. The Administrator may contact the user, in whose account an aberrant set of estimates has been found, to notify him or her of the irregularity. A user who fails to provide reasonable-basis, good-faith estimates may be blocked from further participation in the survey. User concerns or disputes would be addressed by communicating with the Administrator.

Purchases of Wiki Financial Analyst Pay-for-View services will be transacted through established methods of clearing credit card payments and “Pay-Pal” payments. While the Wiki Financial Analyst Database will retain a record of each Pay-for-View purchase, the database will not retain any information specific to user credit card accounts or Pay-Pal accounts.

We claim:

1. A method and software, operating on a computer server and through an internet interface, which mediates a comprehensive on-going survey of: (1) future values for every persistent accounting line-item in a projection model of a company or municipality, and, (2) values of components of calculation of entity value by the method of discounting cash flows to the firm—for the purpose of providing respondents with immediate perspective, on where their individual estimates lie, within the survey's current sample-distribution of peer estimates, for the same accounting line-item and valuation categories.
The claimed type of survey uses the exact accounting nomenclature, as specifically used by each subject-company or subject-municipality in its period financial reports to the US SEC or similar national or transnational monitor. Where certain accounting line-items appear only for a single reporting period, these may be ignored by the survey. Any changes made, to a line-item category name, shall preserve the original meaning, while improving brevity and preventing confusion. (For example, a company might use the same category name in two places in one financial statement, such as “Deferred tax” appearing in both the “Assets” and “Liabilities” sections of a Balance Sheet. The company assumes a human reader will discriminate by the context, but such duplication confuses a computer).
The claimed accounting line-item categories surveyed are organized into standard financial report statements and displays of valuation calculations by the method of discounting free cash flows to the firm (“DFCFF”). In the invention, each subject-entity is represented by five financial statements: future Income Statements (both annual and quarterly); future Balance Sheets; and, calculations for discounted free cash flows to the firm (DFCFF). The display of valuation calculations by the method of discounting free cash flows to the firm is as described in standard texts of equity asset valuation (see Arzac or Stowe). Surveys of non-standard accounting line-item categories (often used in cross-sectional analysis) are not claimed.
The claimed type of survey employs a comprehensive structure for the reporting entity (company or municipality) that includes all the persistent accounting line-item categories of both annual and quarterly Income Statements and Balance Sheets, across several projected reporting periods, as well as the DFCFF calculations associated with these categories. Selective surveys of opinions, as to the future value of single accounting line-items for a single future period, are not claimed. Surveys (archives) of historical financial data, whether comprehensive or selective, are not claimed.
The claimed type of survey provides immediate “feed-back” to the respondent, in an immediate in-kind exchange of individual estimates for aggregated peer estimates. This feedback specifies where the respondent's individual projection values lie within the current sample distribution of peer projections, for the same accounting line-item category and projected time period. Comprehensive surveys of respondent financial opinions, which do not provide immediate feed-back to the respondent, but which are assimilated by a study editor, and are later reported to consumers in essay form, are not claimed.
We propose a simple test to define the boundaries of the claim. The test provides parameters for deciding that the survey: (a) uses the exact accounting nomenclature of the reporting entity (business or municipality), AND, (b) provides a comprehensive series of accounting categories to capture forward-looking financial estimates, AND, (c) provides immediate in-kind feed-back to the respondent.
(a) The claimed survey will be considered to use the exact accounting line-item names used by a business or municipality if it uses the same first 20 letters of the specified accounting line item. Parenthetical explanations, or, specifications of amounts included in the category for one reporting period, may both be ignored. Other text may be added to the survey category name in situations where the original accounting name is ambiguous to a computer database. (For example, when the business or municipality reports “Deferred tax” in both the Assets and the Liabilities sections of its Balance Sheets, the survey may add text to make these category names unambiguous to a computer database. The first use might be called “Deferred tax asset” and the second use might be called “Deferred tax liability”.)
(b) The claimed survey of forward-looking financial estimates can be considered comprehensive if it contains 90% or more of the usually-reported accounting line-items (row names) of the annual and quarterly Income Statements, AND the annual and quarterly Balance Sheets, AND the component calculations of discounting free cash flows to the subject-firm. Certain accounting line item categories are not “usually reported” when they appear in one period report, but not in the previous or subsequent reports of the same type. (For example, “Gains or losses on the sale of assets”, may be one-time events that would not be reported in previous, or subsequent, Income Statements, and so, would not be included in our test of comprehensiveness.)
(c) The claimed survey will be considered to provide an immediate feed-back of in-kind information if the survey provides a display that compares the respondent's estimate to the mean value of the aggregate of peer estimates in the selected accounting line-item and reporting period. To be considered “immediate” the in-kind information display must become available within 60 minutes of the respondent's submission.
